(19) United States
(12) Patent Application Publication
(10) Pub. No.: US 2010/0031546 A1
(43) Pub. Date: Feb. 11, 2010

(54) Assembleable sign

(76) Inventor: Onah Ikechukwu Nwatu, SICKLERVILLE, NJ (US)

Correspondence Address: GEARHART LAW, LLC, 4 FERNDALE ROAD, CHATHAM, NJ, 07928, US

(21) Appl. No.: 12/462,616

(22) Filed: Aug. 6, 2009

Related U.S. Application Data
(60) Provisional application No. 61/087,215, filed on Aug. 8, 2008.

(51) Int. Cl. G09F 15/02

(52) U.S. Cl. 40/607.1

(57) ABSTRACT

The present invention is an article of manufacture, more particularly a sign. The sign is preferably freestanding, having a post assembly constructed from at least two elongated sections. Each elongated section having two ends, and each elongated section having means for removably connecting one end of the elongated section to the end of another elongated section, thereby creating a post assembly. The bottom end of the post assembly connected to a base, suitable for maintaining the post assembly in a substantially vertical position, and with a top end of the post assembly connected to a sign assembly. One alternative embodiment for the post assembly is to replace one or several of the post sections with springs. An alternative embodiment for the base is a convex bottom, with an outwardly curved section pointing downward. Both of these alternative embodiments, as well as a filled up base promote the upright quality of the present invention.

### CLAIM OF PRIORITY

This application claims priority to U.S. Ser. No. 61/087,215. filed on Aug. 8, 2008, the contents of which are fully incorporated herein by reference.

### FIELD OF THE INVENTION

The invention relates to a road sign, in particular, to a collapsible sign that functions as a guide device for parking an automobile within a garage or other parking spot.

### BACKGROUND OF THE INVENTION

The present invention is an assembleable sign which is related to a class of signage known as traffic signs, road signs, or parking signs that impart information to automobile users and pedestrians. The present invention is a significant improvement over prior art in that it is collapsible and lightweight, yet stable and simple to operate, and can be used as a road sign or as a parking guide.

Known prior art road signs and parking guides include U.S. Pat. No. 3,621,807; U.S. Pat. No. 4,619,220; U.S. Pat. No. 4,965,571; U.S. Pat. No. 7,340,854; U.S. Pat. No. 7,350,328.

The U.S. Pat. No. 3,621,807 discloses a guide device for parking an automobile, or the like, to dispose its front or rear bumper at a predetermined distance from the inner end wall of a garage, or the like, comprising a sign in the form of a hex-shaped member mounted on the wall in spaced relation therefrom and about level with the vehicle operator's line of sight, having a window opening formed in its mid-portion in which a slat is mounted for swinging movement about a horizontal axis at its midportion, with the slat being balanced such that under the action of gravity, it is disposed substantially edgewise to the plane of the sign.

The U.S. Pat. No. 4,619,220 shows a roll-up portable roadside sign of the type normally used with a resilient stand member. Such mounting is achieved by pivotably attaching the warning flag poles to the substantially vertical cross member of the sign. A rotatable support bracket is also attached to the cross member and includes a pair of spaced curled ends which receive the warning flag poles such that they extend substantially upward and are disengageable thereform in order to permit collapsing of the sign assembly.

The U.S. Pat. No. 4,965,571 discloses a motor vehicle driver-indicator guide device for signifying when it is safe to advance, including support structure mounting a light or a sign signaling structure viewable by a driver of a motor vehicle, with an actuating lever actuatable an advancing motor vehicle's bumper.

The U.S. Pat. No. 7,340,854 describes an improved sign post assembly for roadway use, wherein a sign post includes a lower section adapted for anchoring to the earth, a mating upper section and a magnetic coupling assembly for maintaining the sections during normal use while permitting breakaway of the upper section when the host is struck by a vehicle.

The U.S. Pat. No. 7,350,328 discloses a traffic sign system that permits an automatic deployment thereof from a moving vehicle. The foldable, spring loaded sign may be deployed without assembly of the traffic sign at a desired display location.

The above patents all describe various road signs, sign posts and parking guides. The present invention fills a needed void and represents a significant improvement over prior art. A greater versatility is accomplished by a freestanding capability of the present invention, with the post assembly secured above ground. It is also self-contained; not requiring any electricity, garden tools, or any specially designed deployment mechanisms for its implementation and usage. The simple, yet effective design of the present invention allows for quick and easy implementation, long term of use and low cost of production. Another major improvement embodied in the present invention is its ability to remain upright.

The present invention may be employed in a wide variety of environments. For instance, it may be used to mark a spot in a garage or parking lot, it may be used as a line marker for children, for instance in a school line or daycare line. It may also be used to mark a crosswalk, a construction area, or as a line marker or informational tool at airports or any other travel areas. Other areas of use will become apparent after the invention is manufactured and sold.

The rugged and flexible nature of the invention makes it particularly amenable to the above situations; automobiles, children, or irate travelers could abuse the invention and it wouldn't break or be easily pushed over or moved out of the way. Rugged construction would allow it to be left outside; alternately, if the base is not weighted too heavily the invention could be used outside and stored inside. Additionally, the invention could be easily moved from place to place. Due to the modular nature of the invention, the sign assembly could be modified or interchanged to allow the invention to be used in any application necessary.

One embodiment of this invention is illustrated in the accompanying drawings and will be described in more detail herein below.

### SUMMARY OF THE INVENTION

The present invention is an article of manufacture, more particularly a sign. The sign is preferably freestanding, having a post assembly constructed from at least two elongated sections. Each elongated section having two ends, and each elongated section having means for removably connecting one end of the elongated section to the end of another elongated section, thereby creating a post assembly. Each section of the post assembly should preferably be 12 inches long with a diameter to length ratio being from a 1 to 4 to a 1 to 16. The bottom end of the post assembly connecting to a base, suitable for maintaining the post assembly in a substantially vertical position, and with a top end of the post assembly connected to a sign assembly.

It is an object of this invention to provide a sign that can be assembled from sections, and which can be disassembled.

Another object of the present invention is to provide a sign disposed on a post assembly that can be used as a road sign, a parking sign or a parking guide.

Yet another object of the present invention is to provide a garage parking guide.

Yet another object of the present invention is to provide a secure signpost, capable of standing upright on its own base.

Yet another object of the present invention is to provide a rocking signpost that will return to an upright position after being struck down.

Yet another object of the present invention is to provide a sign post assembly with integrated springs to serve as shock absorbers and to enable a rocking feature of the present invention.

Yet another object of the present invention is to provide a signpost or a parking guide, which can easily be assembled and used by an average consumer.

### BRIEF DESCRIPTION OF THE DRAWINGS

FIG. 1 is a frontal perspective view of a preferred embodiment of the present invention, showing an upright post made of several sections, a square base and a sign assembly.

FIG. 2 is an exploded perspective view, showing various components of the present invention.

### DESCRIPTION OF THE PREFERRED EMBODIMENTS

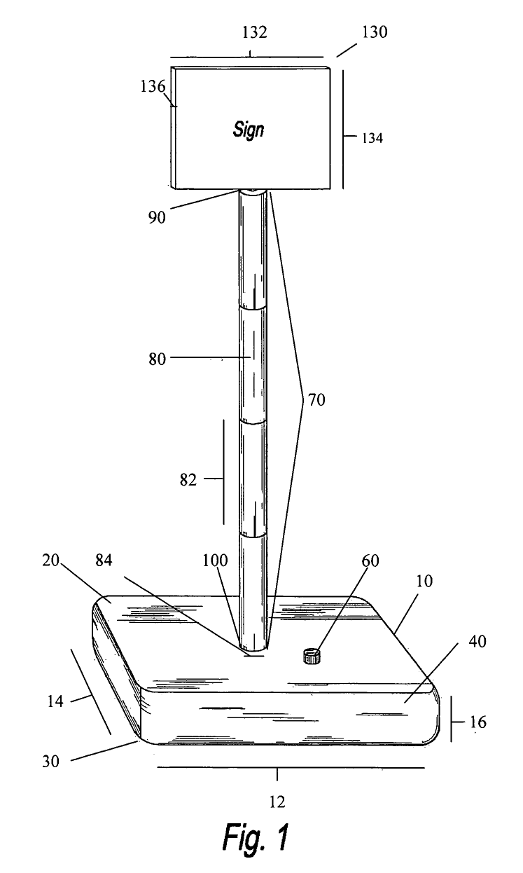

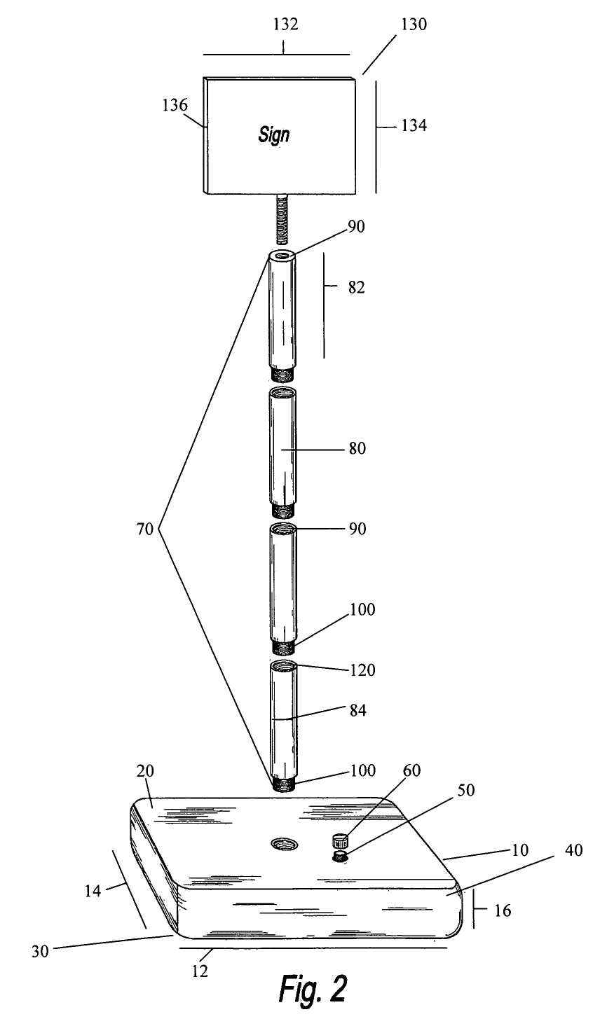

The preferred embodiments of the present invention will now be described with reference to FIG. 1 and FIG. 2 of the drawings. Identical elements in the figures are identified with the same reference numerals. This invention discloses a sign assembly, a post assembly and a base that are suited to be collapsibly assembled together. FIG. 1 shows a base 10, with a base length 12, a base width 14, a base depth 16, a top surface of the base 20, a bottom surface of the base 30, a sidewall of the base 40, a cover 60, a post assembly 70, a post section 80 with a post section length 82, a post section diameter 84, a top end 90, a bottom end 100, and a sign assembly 130 with a sign assembly length 132, a sign assembly width 134, and a sign assembly depth 136.

Still referring to FIG. 1, the post assembly 70 can be constructed from two or more individual post sections 80. The post sections 80 should preferably be between 12 and 16 inches in length. The post sections 80 should preferably be hollow to keep the top section of the present invention from becoming very top heavy as the post assembly 70 gets longer with each additional post section 80. The post sections 80 can also be made solid even for extra long post assemblies 70, if a lightweight material is used. Disclosed is a post assembly 70 made from four individual post sections 80, but it can be made from 2 or more post sections 80. Each post section 80 is preferably 12 inches in length. FIG. 1 shows a post assembly 70, where all post sections 80 are of equal length. Alternatively, the length of the post sections 80 can vary. The ratio of the length of each post section 80 to its diameter is preferably between 1 to 4, and 1 to 16. The post sections 80 should preferably be plastic or wood, but can also be made from any material, including but not limited to, metal, flexible rubber or any other elastic hydrocarbon polymer, carbon fiber, polyvinyl chloride, or any composite of these materials. It is important to note that any part of the sign, in whole or in part, can have reflective materials disposed on it. The reflective materials can be paint, tape or integral with the plastic. The reflective materials will help make the sign more visible in dark conditions.

Any of the various components of the invention can be any color or combination of colors, and may contain markings, such as but not limited to, indicia, pictures, instructions, or any desired markings. Various components may have similar or varying markings or colors, or varying or similar combinations thereof.

Still referring to FIG. 1 the sign assembly 130 is calculated to contain an informational or a cautionary message, such as “stop” or “children at play.” Such message can be transcribed directly onto the sign assembly 130, or be contained on separate strips of material that would be removably attached to the sign assembly 130. The sign assembly 130 should preferably be made of strong, weather resistant, shatter proof material, since the present invention would need to be able to tolerate moderate collisions with pedestrians and motor vehicles. The materials used include, but are not limited to, plastics, rubbers, thermoplastics, elastomers, glass products such as but not limited to fiberglass, wood, metals, or any suitable other material or combination of the above with each other or any other materials.

The sign assembly could be made such that it is reversible; for instance, one side may bear the indicia “stop”, while the other side bears the indicia “go”. The sign assembly may be affixed to the top post section such that it can be swiveled between the two positions. The indicia on the two sides may be the same height, font, coloring, or they may be different.

Additionally, the invention could be sold with one base assembly and one set of post sections, but a variety of sign assemblies so the invention could be used in a variety of applications. Due to the ease of transportation of the invention, this is a valued feature. The invention may be sold as a set including a base assembly, post sections, and a sign assembly; additionally, these components may be sold separately as in a modular system, as replacement parts, or as extra parts for extended height of the invention or for varying uses such as using multiple sign assemblies. If used without the base, the bottom post section could be permanently anchored in the ground.

The sign assembly may be any shape, such as but not limited to, square, rectangular, round, octagonal, diamond, animal shape, character shape, or a three dimensional shape, such as but not limited to, a pyramid, cube, or any other shape or combination of shapes. The sign assembly may have hooks or a compartment for keys or other items, particularly in the three dimensional shape. The sign assembly may be any color or combination of colors, and may display any markings, including but not limited to, indicia, pictures or drawings, photographs, advertising, or any other desired marking. The markings may be permanent or temporary and removable. The sign assembly may include warnings in Braille for use in pedestrian areas.

FIG. 2 is an exploded frontal view of the preferred embodiment. Shown in this diagram are a base 10, with a base length 12, a base width 14, a base depth 16 a top surface of the base 20, a bottom surface of the base 30, a sidewall of the base 40, a fill opening 50, a cover 60, a post assembly 70, a post section 80, with a post section length 82, a post section diameter 84, a top end 90, a bottom end 100, a male connector 110, a female connector 120, and a sign assembly 130 with a sign assembly length 132, a sign assembly width 134, and a sign assembly depth 136.

The post sections 80 are held together by means of corresponding male and female connectors, 110 and 120 respectively. Note that the preferred embodiment discloses a threaded screw and nut engagement between the male connector 110 and the female connector 120. This connection can also be frictional or be secured with a peg inserted into the joint between adjoining sections 80. The frictional union may employ joiner pieces to join two post sections together. One or more of the sections 80 can be replaced with a spring of equal, greater, or lesser length as the section 80 that it replaced. The spring and sections 80 will have compatible means of coupling to one other. The spring would enable the post assembly 70 to absorb the force of an impact with an automobile or a pedestrian and to return to an upright position after the impact. Such a spring should preferably be made of a metal or metal alloy to maximize its strength, but it may be made of any material, including but not limited to, plastic, glass products, wood, rubber, or any combination of these or other materials.

Still referring to FIG. 2, the top end 90 of the post assembly 70 is suited to accommodate a sign assembly 130. The sign assembly 130 is pictured with a threaded male connector 110 that would be fitted into a female connector 120 of the post section 80. It can also be a frictional connector, a snap-on, a hook and loop, or any other removable attachment. The bottom end 100 of the post assembly 90 is pictured containing a male connector 1 10 which engages the female connector of the base 10 with a thread induced coupling. A threaded nut and bolt connection is ideal in this part of the assembly, since it increases strength and structural integrity of all upper components of the present invention. However, the connection can be any type, including but not limited to, frictional, snap-on or any other secure, but removable coupling.

Still referring to FIG. 2, the base 10 is pictured as being square in appearance, but can be rectangular, circular or any other geometric or decorative shape. A square base 10 should preferably be 8 inches long, 8 inches wide, with 4 inches for the width of the sidewall 40. A rectangular base should preferably be 8 inches long, 12 inches wide and 4 thick. A circular base should preferably be 12 inches in diameter and 4 inches for the width of the sidewall 40. These dimensions ensure the most stable connection with the ground while minimizing the physical footprint of the base 10. The base 10 should preferably be made from plastic, but can also be made from any material, such as but not limited to, metal, stone, concrete, wood or carbon fiber or any composite of these materials. The base 10 would be hollow inside and filled with water, sand, rocks, or any other filler to increase the weight of the base 10. A heavy base 10 would promote a vertical position of the present invention that would resist toppling over upon impact. The bottom surface 30 of the base 10 is pictured as being flat or stable, to increase the contact area with the ground and thereby increase the frictional coefficient between the present invention and the surface upon which it would be placed. Alternatively, the bottom surface 30 can be made convex, with the outward curve pointing toward the ground. This would promote a rocking feature of the present invention.

Still referring to FIG. 2, the cover 60 can be made of the same material as the base 10, or can be made of any other material. It would likely be finished in a bright color to be readily noticeable, or be of the same color as the base. The preferred embodiment discloses a cover 60 that is fastened to the fill opening 50 using a threaded coupling. Such connection provides the most secure way of retaining the contents of the filler for the base 10. However, the cover 60 can also be snapped into place, or inserted into the fill opening 50 as a peg. A solid base 10 would obviate the need for the fill opening 50 and the cover 60.

The present invention is intended to be used as a parking guide for a garage, driveway or a parking spot. A driver would continue moving his or her motor vehicle in the direction of the sign, until the bumper of the car would cause the post assembly 70 to topple or lean over. This would server as a signal to the driver to stop the automobile.

The sign would also serve to display a cautionary or informative message, such as “warning,” “caution,” or “children at play.” The weeble-wobble quality of the sign makes it very suitable for use in windy areas, such as parks, streets and playgrounds. In these areas, a sign would likely be blown down by the wind or get knocked down by a motor vehicle or a pedestrian. The rocking quality would ensure that the sign would resume its upright position most of the time.

In the most preferred embodiment, the invention includes a weightable base, 3 post sections, a post assembly, and a sign assembly. The 3 identical post sections each have a 1-2 inch wide reflective tape encircling their bodies, and differing ends; one end is widened, while the other end is the same width as the post section body. Thus, the widened end may be slipped over the non-widened end to join the post sections together using friction. The post assembly allows the sign assembly to be attached to the post sections; it has a widened end that slips over the post section end that is non-widened, and a groove or slot at the top to accommodate the sign assembly.

In this same embodiment, the sign assembly is smaller than the base assembly. The smaller size of the sign assembly helps keep the sign stable when bumped or in windy weather. Particularly, the sign assembly length is proportionately approximately 50% to 90%, or 70% to 90% of the base length, and the sign assembly width is approximately 50% to 90%, or 70% to 90% of the base width, and the sign assembly depth is 0.01% to 80% of the base depth. Additionally, the sign assembly length is 10-99% of the sign assembly width.

Although this invention has been described with a certain degree of particularity, it is to be understood that the present disclosure has been made only by way of illustration and that numerous changes in the details of construction and arrangement of parts may be resorted to without departing from the spirit and the scope of the invention.

I claim:

1. An article of manufacture, comprising:
a post assembly, the post assembly constructed from at least two elongated sections, each elongated section having two ends, and each elongated section having means for removably connecting one end of the elongated section to the end of another elongated section, thereby creating a post assembly;
a base, suitable for receiving a bottom end of the post assembly and maintaining the post assembly in a substantially vertical position; and
a sign assembly, suitable for attachment to a top end of the post assembly.

2. The article of claim 1, wherein the post assembly has at least three sections.

3. The article of claim 1, wherein the post assembly has at four sections.

4. The article of claim 1, wherein the sections are about 1 foot long.

5. The article of claim 2, wherein the sections are about 1 foot long.

6. The article of claim 3, wherein the sections are about 1 foot long.

7. The article of claim 1, wherein the sections are made of plastic.

8. The article of claim 1, wherein the sections are made of wood.

9. The article of claim 1, wherein the sections are made of flexible rubber.

10. The article of claim 1, wherein the base is stable.

11. The article of claim 1, wherein the base is able to rock when a force is exerted on a section.

12. The article of claim 1, wherein the base may be filled with sand or water.

13. The article of claim 1, wherein the base has a rounded bottom surface.

14. The article of claim 1, wherein the sign has the word “stop” disposed thereon.

15. The article of claim 1, wherein the means for removably connecting is a fastener having a male portion in one section and a corresponding female portion in another section.

16. The article of claim 1, wherein the post assembly has identical sections.

17. The article of claim 15 wherein the base assembly has a length and the sign assembly has length and the sign assembly length is approximately 50% to 90% of the base assembly length.

18. The article of claim 1, wherein each section has a length and a diameter, and the ratio of the length to the diameter is no greater than 16.

19. The article of claim 1, wherein each section has a length and a diameter, and the ratio of the length to the diameter is about 12.

20. The article of claim 1, wherein each section has a length and a diameter, and the ratio of the length to the diameter is between 4 and 12.
